(19) United States
(12) Patent Application Publication
(10) Pub. No.: US 2004/0016338 A1
(43) Pub. Date: Jan. 29, 2004

(54) System and method for digitally processing one or more audio signals

(75) Inventor: Jeremy M. Dobies, Hacienda Heights, CA (US)

Correspondence Address: TEXAS INSTRUMENTS INCORPORATED, P O BOX 655474, M/S 3999, DALLAS, TX, 75265

(73) Assignee: Texas Instruments Incorporated

(21) Appl. No.: 10/205,044

(22) Filed: Jul. 24, 2002

(51) Int. Cl. G10H 1/02

(52) U.S. Cl. 84/662; 84/664; 381/61; 381/62

(57) ABSTRACT

A method for processing an audio signal is provided that includes receiving an audio signal and integrating the audio signal with a selected one of a plurality of sound effects. The method also includes generating an output that reflects the integration of the audio signal and the selected sound effect. The output may then be communicated to a next destination.

### TECHNICAL FIELD OF THE INVENTION

This invention relates in general to digital processing and more particularly to a system and method for digitally processing one or more audio signals.

### BACKGROUND OF THE INVENTION

Signal processing has become increasingly important in acoustical and audio technology environments. The ability to properly manipulate audio signals is critical in achieving a desired sound result. Sound and recording engineers are continuously struggling with how to achieve desired tones, acoustical parameters, and sound effects which are produced in the most efficient possible manner. Similarly, musicians are confronted with the task of producing targeted sounds based on sound control parameters that are generally offered on a per-instrument or per-component basis. In some cases, a musician or a sound engineer is confined to a single sound effect employed in a single unit for a particular device. Such a restriction significantly inhibits the ability to control or manipulate audio data as it is being composed, played, or heard. Moreover, in order to provide an adequate variety of potential sound effects, numerous sound effect system enhancements or add-ons must be purchased, but they only provide a single sound parameter to be infused into a musical composition, piece, or recording. This represents a significant economic burden for persons that seek to maintain a selection of viable potential sound effects.

### SUMMARY OF THE INVENTION

From the foregoing, it may be appreciated by those skilled in the art that a need has arisen for an improved processing approach that provides the capability for the accurate manipulation or modification of audio signals and sound effects in a communications environment. In accordance with one embodiment of the present invention, a system and method for processing an audio signal are provided that substantially eliminate or greatly reduce disadvantages and problems associated with conventional signal processing techniques.

According to one embodiment of the present invention, there is provided a method for processing an audio signal that includes receiving an audio signal and integrating the audio signal with a selected one of a plurality of sound effects. The method also includes generating an output that reflects the integration of the audio signal and the selected sound effect. The output may then be communicated to a next destination.

Certain embodiments of the present invention may provide a number of technical advantages. For example, according to one embodiment of the present invention, a processing approach is provided that provides considerable flexibility in manipulating one or more audio signals. The increased flexibility is a result of the digital processing of audio signals. Such digital processing allows a musician to download any particular sound effect or sound parameter into a processing module. The processing module may then be used in conjunction with the instrument, microphone, or any other element in order to achieve the desired sound effect(s) or sound parameter(s) as the musical composition is being played. Accordingly, any sound parameters or sound effects may be infused into a musical composition with relative ease as information or data is received through a programmable interface positioned within or coupled to the processing module.

Another technical advantage of one embodiment of the present invention is a result of the time interval specific feature provided to the processing module that digitally processes the audio signals. The time interval specific feature allows a musician or a recording or sound engineer to position sound effects at specific points in time. Such sound effects may be positioned on individual tracks whereby each track represents a single instrument, microphone, or other sound-producing element that is participating in the musical composition being performed. This offers enhanced creative freedom in being able to exactly position multiple sound effects or sound parameters at designated points in time. For example, this would allow a distortion of a guitar and a piano to begin thirty seconds after the musical composition has started. The sound or recording engineer also benefits from the ease in which such time interval specific positioning may be implemented. This enhances the potential synergy between musical instruments and accompanying sound effects and generally broadens the creative scope of music composition. Embodiments of the present invention may enjoy some, all, or none of these advantages. Other technical advantages may be readily apparent to one skilled in the art from the following figures, description, and claims.

### DETAILED DESCRIPTION OF THE INVENTION

FIG. 1 is a simplified block diagram of a processing system 10 for digitally processing one or more audio signals in a communications environment. Processing system 10 includes an audio processing module 14 that includes a programmable interface 18, a mechanical interface unit 20, a digital signal processor 24, a codec 28, and a memory element 30. In addition, processing system 10 includes multiple audio inputs 34a-34d, a sound effects data input 38, and an audio output 40.

Audio processing module 14 operates to receive a selected one or more of audio inputs 34a-34d and integrates the selected audio signals with one or more sound effects. The sound effects may be stored in memory element 30 or in any other suitable location of audio processing module 14. Digital signal processor 24 and codec 28 may operate in combination or independently in order to convert an incoming analog signal from any one of audio inputs 34a-34d into a digital format for suitable processing or integration with selected sound effects. The digital integration of audio inputs 34a-34d and selected sound effects may be then converted back into an analog format to be communicated through audio output 40 and to a next destination such as for example an amplifier or a music sound board.

Processing system 10 provides considerable flexibility in manipulating one or more audio signals. The increased flexibility is a result of the digital processing of the incoming audio signals. Such digital processing allows a musician to download any particular sound effect or sound parameter into audio processing module 14. Audio processing module 14 may then be used in conjunction with the instrument, microphone, or any other element in order to achieve the desired sound effect(s) or sound parameters as the musical composition is being played. Thus, any sound parameters or sound effects may be infused into a musical composition with relative ease as information is received through programmable interface 18 positioned within or coupled to audio processing module 14.

Audio processing module 14 is a component operable to store one or more sound effects to be implemented or otherwise integrated with audio inputs 34a-34d. Audio processing module 14 may include a number of elements that cooperate in order to digitally process an audio signal such that a result is produced that reflects the audio signal being influenced or otherwise changed by a selected sound effect. In addition to the components described below, audio processing module 14 may additionally include any other suitable hardware, software, element, or object operable to facilitate processing of the audio signal in order to generate a desired sound result.

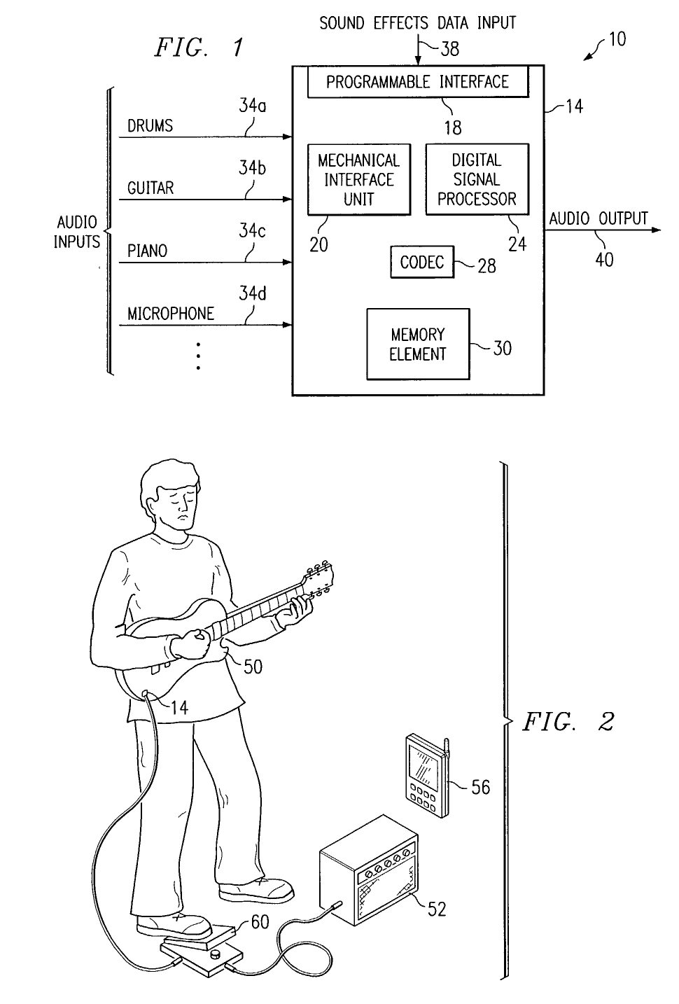

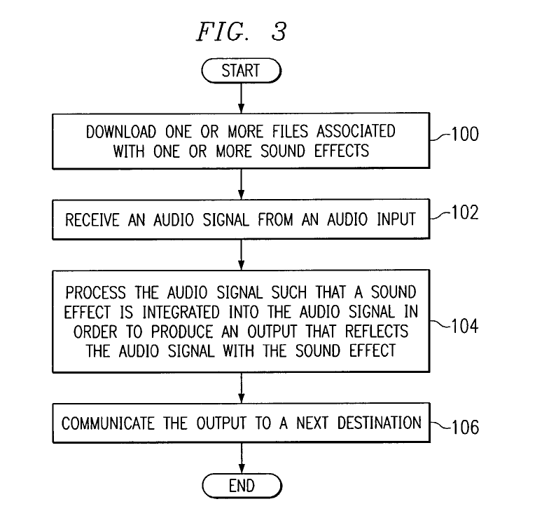

As illustrated in FIG. 1, audio processing module 14 may include a coupling or link to a source that provides sound effects data or information such that any number of selected sound effects may be downloaded or otherwise communicated to audio processing module 14. Audio processing module 14 may additionally be coupled to an initiation or triggering mechanism for sound effects data to be implemented. Such mechanisms may include a foot pedal 60 (as illustrated in FIG. 2), a switch, or a lever that operates to initiate one or more selected sound effects for an instrument being played or for a microphone being used. Audio processing module 14 may be any suitable size and shape such that it is conveniently accessible by a musician, a sound engineer, or any other person or entity wishing to integrate sound effects with an audio input. Additionally, as illustrated in FIG. 2 and described in greater detail below with reference thereto, audio processing module 14 may be positioned directly on an instrument or a microphone where appropriate. Such positioning may have negligible effects on the weight, dimensions, and operability of an associated instrument or microphone.

Programmable interface 18 is an element that operates to receive sound effects data and deliver that information to audio processing module 14. Programmable interface 18 is a universal system bus (USB) cable in accordance with one embodiment of the present invention. However, programmable interface 18 may be any other suitable interface such as an RFC 802.11 communications protocol interface, a Bluetooth interface unit, or any other suitable software, hardware, object, or element operable to facilitate the delivery or exchange of data associated with sound effects. Programmable interface 18 may be coupled to the world wide web or Internet such that selected files and designated sound effects information may be appropriately downloaded or otherwise communicated to audio processing module 14. In addition, numerous other devices may interface with programmable interface 18 in order to deliver specified sound effects information or data. For example, a central processing unit (CPU) may be coupled to audio processing module 14 via programmable interface 18. This would allow an end user to take files stored on the CPU and communicate this information to audio processing module 14. Additionally, any other suitable element such as a personal digital assistant (PDA), a cellular telephone, a laptop or electronic notebook, or any other device, component, or object may be used to deliver files to audio processing module 14.

Mechanical interface unit 20 is a tuning mechanism that may be accessed by an end user using audio processing module 14. Mechanical interface unit 20 may include switches, knobs, levers, or other suitable elements operable to effect some change in the audio signal being processed by audio processing module 14. Mechanical interface unit 20 may also include bypass switching elements and power-up and power-down controls. Mechanical interface unit 20 may be accessed and used at any time during the audio signal processing execution whereby acoustical parameters associated with the sound effect(s) being produced may be modified, manipulated, or otherwise changed based on the operation of the switches, knobs, and levers.

Digital signal processor 24 is a programmable device with an instruction code that provides for the conversion of analog information into a digital format. Digital signal processor 24 receives one or more of audio signals from audio inputs 34a-34d and appropriately processes the incoming analog signal such that it is converted into a digital format for further manipulation. Digital signal processing generally involves a signal that may be initially in the form of an analog electrical voltage or current produced for example in conjunction with the sound that resonates from a microphone, a guitar, a piano, or a set of drums. In other scenarios, the incoming data may be in a digital form such as the output from a compact disk player. The incoming analog signal may be generally converted into a numerical or digital format before digital signal processing techniques are applied. An analog electrical voltage signal, for example, may be digitized using an accompanying analog-to-digital converter (ADC) whereby after the conversion is executed the digital signal processing may occur. This generates a digital output in the form of a binary number the value of which represents the electrical voltage. In this form, the digital signal may then be processed with the sound effect being implemented or otherwise integrated with the selected audio signal. The use of digital signal processing in order to obtain a desired set of sounds provides considerable flexibility in the array of audio signals and results that may be generated. Digital signal processor 24 may operate in conjunction with codec 28 or independently where appropriate and according to particular needs.

Codec 28 is an element that performs analog-to-digital conversions or suitable compression/decompression techniques to incoming audio data. Codec 28 may include suitable algorithms or computer programs that operate to provide the conversion of analog signals to digital signals. Codec 28 may operate in conjunction with digital signal processor 24 in order to suitably process audio inputs 34a-34d as they are being integrated with selected sound effects. Alternatively, codec 28 may be included within digital signal processor 24 or eliminated entirely where appropriate such that one or more of its functions are performed by one or more elements included within audio processing module 14.

Memory element 30 is a memory element that stores files associated with sound effects to be integrated with audio signals received from audio inputs 34a-34d. Memory element 30 may alternatively store any other suitable data or information related to sound effects sought to be integrated with audio signals received by audio processing module 14. Memory element 30 may be any random access memory (RAM), read only memory (ROM), field programmable gate array (FPGA), erasable programmable read only memory (EPROM), electronically erasable programmable read only memory (EEPROM), application-specific integrated circuit (ASIC), microcontroller, or microprocessor element, device, component, or object that operates to store data or information in a communications environment. Memory element 30 may also include any suitable hardware, software, or programs that organize and select files associated with sound effects to be used in conjunction with processing system 10. Memory element 30 may additionally include suitable instruction sets that operate to integrate selected sound effects with designated audio inputs 34a-34d.

Audio inputs 34a-34d represent couplings to instruments, microphones, and other sound-producing elements or devices. For purposes of example only, a set of instruments have been illustrated in FIG. 1 which include drums, guitar, piano, and microphone. Numerous other instruments and sound-producing elements may be provided as audio inputs 34a-34d to audio processing module 14 such that the incoming audio signal is suitably integrated with sound effects before being communicated to a next destination. Audio inputs 34a-34d may originate from the sound-producing device and may be internal to audio processing module 14 in cases where audio processing module 14 is mounted directly on the sound-producing element.

Sound effects data input 38 represents a communication pathway for data, files, or information associated with sound effects to be integrated with audio inputs 34a-34d. Sound effects data input 38 may originate from any suitable source such as the world wide web, a CPU, a PDA, or any other suitable element operable to transfer data or information associated with a sound effect. The sound effects may be stored in a file or simply maintained in a subset of data or information with accompanying software or hardware that facilitates the delivery of information. In addition, the sound effects may be stored in any form of object code or source code such that the information may be suitably provided to audio processing module 14 for integration with selected audio inputs 34a-34d.

Any number of potential sound effects may be downloaded or otherwise communicated to audio processing module 14 using sound effects data input 38. Programmable interface 18 provides the coupling between sound effects data input 38 and audio processing module 14. The sound effects may be any suitable object or element operable to effect some change in an audio signal being received by audio processing module 14. For purposes of teaching, a number of example potential sound effects are described below. This list of potential sound effects is not exhaustive, as any number of additional suitable sound effects may be used in conjunction with processing system 10 where appropriate and according to particular needs.

One example of a set of sound effects are those based on variations in the loudness/volume of the signal. Sound effects based on variations in signal loudness, tone, timing, or pitch may include volume control, panning compression, expansion, noise gating, attack delay, echo, reverberation, chorus, flanging, phasing, and various others as described individually in more detail below.

In the simplest form, volume control is the controlling of the amplitude of the signal by varying the attenuation of the input signal. However, an active volume control may have the ability to increase the volume (i.e. amplify the input signal) as well as attenuate the signal.

Volume controls are useful in being positioned between effects such that the relative volumes of the different effects can be kept at a constant level. However, some effects may have volume controls built-in, allowing the end user to adjust the volume of the output with the effect on relative to the volume of the unaffected signal (when the effect is off).

Volume pedals may control volume control and are generally used in a way similar to wah-wah pedals: they may create “volume swell” effects and fade in from the attack of a note, thus eliminating the attack. This can be used, for example, to make a guitar sound like a synthesizer by fading it in after a chord is strummed. A digital variation of this is the tremolo. This effect may vary the volume continuously between a minimum volume and a maximum volume at a certain rate.

Panning is used in stereo recordings. Stereo recordings generally have two channels, left and right. The volume of each channel may be adjusted, whereby the adjustment effectively changes the position of the perceived sound within the stereo field. The two extremes being represented by all sound completely on the left, or all sound completely on the right. This is commonly referred to as balance on certain commercial sound systems. Panning may add to the stereo effect, but it generally does not assist in stereo separation. Stereo separation may be achieved by time delaying one channel relative to the other.

Compression amplifies the input signal in such a way that louder signals are amplified less and softer signals are amplified more. It may represent a variable gain amplifier, the gain of which is inversely dependent on the volume of the input signal.

Compression may be used by radio stations to reduce the dynamic range of the audio tracks, and to protect radios from transients such as feedback. It may also be used in studio recordings, to give the recording a constant volume. Using a compressor for a guitar recording may make finger-picked and clean lead passages sound smoother. Compression may increase background noise, especially during periods of silence. Thus, a noise gate may be used in conjunction with the compressor. An expander generally performs the opposite effect of the compressor. This effect may be used to increase the dynamic range of a signal.

A noise gate may operate to gate (or block) signals whose amplitude lies below a certain threshold, and further lets other signals through. This is useful for eliminating background noises, such as hiss or hum, during periods of silence in a recording or performance. At other times, the recording or performance may drown out the background noise.

Noise gates may have controls for hold time, attack time, and release time. The hold time is the time for which a signal should remain below the threshold before it is gated. The attack time is the time during which a signal (that is greater than the threshold) is faded in from the gated state. The release time is the time during which a signal (that is below the threshold) is faded into the gated state. These controls help to eliminate the problems of distortion caused by gating signals that are part of the foreground audio signal, and further alleviate the problem of sustained notes being suddenly killed by the noise gate.

Attack delay is an effect used to simulate “backwards” playing, much like the sounds produced when a tape is played backwards. It operates in delaying the attack of a note or chord by exponentially fading in the note or chord so that it creates a delayed attack.

Another example of a set sound effects are those based on the addition of time-delayed samples to the current audio output. Sound effects based on the addition of the time-delayed samples include echo, reverberation, chorus, flanging, and phasing.

Echo is produced by adding a time-delayed signal to the audio output. This may produce a single echo. Multiple echoes are achieved by feeding the output of the echo unit back into its input through an attenuator. The attenuator may determine the decay of the echoes, which represents how quickly each echo dies out. This arrangement of echo is called a comb filter. Echo greatly improves the sound of a distorted lead because it improves the sustain and gives an overall smoother sound. Short echoes (5 to 15 ms for example) with a low decay value added to a voice track may make the voice sound “metallic” or robot-like.

Reverb is used to simulate the acoustical effect of rooms and enclosed buildings. In a room for instance, sound is reflected off the walls, the ceiling, and the floor. The sound heard at any given time is the sum of the sound from the source, as well as the reflected sound. An impulse (such as a hand clap) will decay exponentially. The reverberation time is defined as the time taken for an impulse to decrease by approximately 60 dB of its original magnitude.

The chorus effect is so named because it makes the recording of a vocal track sound like it was sung by two or more people singing in chorus. This may be achieved by adding a single delayed signal (echo) to the original input. However, the delay of this echo may be varied continuously between a minimum delay and maximum delay at a certain rate.

Flanging is generally a special case of the chorus effect. Typically, the delay of the echo for a flanger is varied between 0 ms and 5 ms at a rate of 0.5 Hz. Two identical recordings are played back simultaneously and one is slowed down to give the flanging effect. Flanging gives a “whooshing” sound, like the instrument is pulsating. It essentially represents an exaggerated chorus.

Phasing is similar to flanging. If two signals that are identical, but out of phase, are added together the result is that they will cancel each other. If however they are partially out of phase, then partial cancellations, and partial enhancements occur. This leads to the phasing effect. Other desired effects can be achieved with variations of echo and chorus.

Another example of a set of sound effects are those that distort the original signal by some form of transfer function (non-linear). Sound effects based on transfer function processing include clipping and distortion.

Symmetrical/Asymmetrical clipping is achieved when a signal is multiplied with the hard-limit transfer function (distortion). Half wave/full wave rectification is achieved when clipping occurs of one-half of the waveform/absolute value of input samples. Arbitrary waveform shaping is achieved when a signal is multiplied by the arbitrary transfer function and may be used to perform digital valve/tube distortion emulation.

Distortion is generally achieved using one of the clipping functions mentioned above. However, more musically useful distortion may be achieved by digitally simulating the analog circuits that create the distortion effects. Different circuits produce different sounds, and the characteristics of these circuits may be digitally simulated to reproduce the effects.

Another example of a set of sound effects includes effects based on filtering-the input signal or modulation of its frequency. Sound effects based on filtering include pitch shifting, vibrato, double sideband modulation, equalization, wah-wah and vocoding.

Pitch shifting shifts the frequency spectrum of the input signal. It may be used to disguise a person's voice, or make the voice sound like that of the “chipmunks” through a “Darth Vader” sound on the voice spectrum. It may also be used to create harmony in lead passages. One special case of pitch shifting is referred to as Octaving, where the frequency spectrum is shifted up or down by an octave.

Vibrato may be obtained by varying the pitch shifting between a minimum pitch and maximum pitch at a certain rate. This is often done with an exaggerated chorus effect.

Double sideband modulation may also be referred to as ring modulation. In this effect, the input signal is modulated by multiplying it with a mathematical function, such as a cosine waveform. This is the same principle that is applied in double sideband modulation used for radio frequency broadcasts. The cosine wave is the “carrier” onto which the original signal is modulated.

Equalization is an effect that allows the user to control the frequency response of the output signal. The end user can boost or cut certain frequency bands to change the output sound to suit particular needs. It may be performed with a number of bandpass filters centered at different frequencies (outside each other's frequency band), whereby the bandpass filters have a controllable gain. Equalization may be used to enhance bass and/or treble.

Wah-wah is also known as parametric equalization. This is a single bandpass filter whose center frequency can be controlled and varied anywhere in the audio frequency spectrum. This effect is often used by guitarists, and may be used to make the guitar produce voice-like sounds.

Vocoding is an effect used to make musical instruments produce voice-like sounds. It involves the dynamic equalization of the input signal (from a musical instrument) based on the frequency spectrum of a control signal (human speech). The frequency spectrum of the human speech is calculated, and this frequency spectrum is superimposed onto the input signal. This may be done in real-time and continuously. Another form of vocoding is performed by modeling the human vocal tract and synthesizing human speech in real-time.

Audio output 40 represents a potential coupling to an amplifier, a music sound board, a mixer, or an additional audio processing module 14. Alternatively, audio output 40 may lead to any suitable next destination in accordance with particular needs. For example, audio output 40 may lead to a processing board where a sound engineer manages a series of tracks that are playing (i.e. guitar, drums, microphone, etc.) The sound engineer may use programmable interface 18 in conjunction with audio processing module 14 in order to control the sound effects to be infused into the musical composition. This provides a customization feature by offering a programmable music sound board whereby any selected information may be uploaded in order to generate a desired audio signal output. A recording engineer may also utilize such a system in digitally recording tracks onto a CPU for example and then adding the desired sound effects to the musical composition.

A time interval specific parameter is also provided to processing system 10 whereby specific sound effects or pieces of information may be designated for particular points in time. Thus, a desired sound effect may be positioned on a channel or on a track at an exact point in time such that the desired audio output is achieved. This may be effectuated with use of a CPU or solely with use of audio processing module 14. In this sense, per-channel or per-track multiplexing may be executed such that desired sound effects are positioned accurately and quickly at designated points in the musical composition.

FIG. 2 is a simplified block diagram of the processing system of FIG. 1 that illustrates an alternative embodiment of the present invention in which audio processing module 14 is included within an instrument. For purposes of example, a guitar 50 is illustrated as inclusive of audio processing module 14 which is coupled to an amplifier 52. Amplifier 52 may be coupled to or replaced with a mixer, a public address (P.A.) system, a sound board, a processing unit for processing multiple audio input signals, an additional audio processing module 14, or any other suitable device or element. In addition, FIG. 2 further illustrates a PDA 56 that may be used to store sound effects data to be communicated or downloaded to audio processing module 14.

In operation of an example embodiment, an end user may use PDA 56 in order to download a desired set of sound effects into audio processing module 14. The end user may then play guitar 50 and experience the desired audio signal outputs via amplifier 52. The end user may retrieve the desired audio files associated with the sound effects via another CPU or the world wide web or any other suitable location operable to store information associated with the sound effects. In addition, sound effects may be downloaded as guitar 50 is being played using any suitable communications protocol such as for example Bluetooth. Additionally, in cases where multiple instruments are being played, a central manager may use audio processing unit 14 in conjunction with PDA 56 in order to manage multiple sections of a musical composition being played. This may be executed using radio frequency (RF) technologies, 802.11 protocols, or Bluetooth technology. Moreover, any suitable device may be used in order to download effects, such as a cellular phone, an electronic notebook, or any other suitable element, device, component, or object operable to store and/or transmit information associated with sound effects.

FIG. 3 is a flowchart illustrating a series of steps associated with a method for digitally processing an audio signal. The method begins at step 100 where one or more files associated with one or more sound effects are downloaded or communicated. Sound effects data may be delivered to audio processing module 14 via programmable interface 18. At step 102, an audio signal may be received from a selected audio input 34a-34d. At step 104, the audio signal may be processed such that one or more sound effects are integrated into the audio signal such that an output or result is generated. The output may then be communicated to a next destination at step 106, such as amplifier 52, a music sound board, or an additional audio processing module 14.

Some of the steps illustrated in FIG. 3 may be changed or deleted where appropriate and additional steps may also be added to the flowchart. These changes may be based on specific audio system architectures or particular instrument arrangements or configurations and do not depart from the scope or the teachings of the present invention.

Although the present invention has been described in detail with reference to particular embodiments, it should be understood that various other changes, substitutions, and alterations may be made hereto without departing from the spirit and scope of the present invention. For example, although the present invention has been described as using a single audio processing module 14, multiple audio processing modules may be used where appropriate in order to facilitate generation of desired sound effects through multiple instruments. In such an arrangement, audio processing modules 14 may be coupled in any suitable configuration or arrangement in order to effectuate the desired audio signal outputs. In addition, each of the audio processing modules 14 may be inclusive of a communications protocol that allows for interaction amongst the elements and additional interaction with any other suitable device, such as a CPU, a PDA, or any other element sought to be utilized in conjunction with audio processing module 14.

Numerous other changes, substitutions, variations, alterations, and modifications may be ascertained by those skilled in the art and it is intended that the present invention encompass all such changes, substitutions, variations, alterations, and modifications as falling within the spirit and scope of the appended claims.

Moreover, the present invention is not intended to be limited in any way by any statement in the specification that is not otherwise reflected in the appended claims. Various example embodiments have been shown and described, but the present invention is not limited to the embodiments offered. Accordingly, the scope of the present invention is intended to be limited solely by the scope of the claims that follow.

What is claimed is:

1. A system for processing an audio signal, comprising:
an audio processing module operable to receive an audio signal, the audio processing module operable to integrate a selected one or more of a plurality of sound effects with the audio signal, the audio processing module operable to generate an audio signal output that reflects the integration of the selected sound effect and the audio signal.

2. The system of claim 1, wherein the audio processing module is operable to store a file associated with the selected sound effect.

3. The system of claim 1, further comprising:
a central processing unit (CPU) coupled to the audio processing module via a universal system bus (USB) cable, wherein the USB cable is used to download one or more files associated with the one or more plurality of sound effects to be integrated with the audio signal received by the audio processing module.

4. The system of claim 1, wherein the audio processing module is operable to provide a manual adjustment for tuning the audio signal as it is integrated with the selected sound effect.

5. The system of claim 1, further comprising:
a wireless device operable to store one or more files associated with one or more sound effects, wherein the wireless device downloads one or more of the files using a Bluetooth communications protocol.

6. The system of claim 1, wherein the audio processing module is operable to process the audio signal such that the selected sound effect may be implemented in a musical composition at a selected time interval.

7. The system of claim 1, further comprising:
a plurality of audio signals received by the audio processing module and digitally processed such that one or more of the sound effects are integrated into one or more of the audio signals, wherein each of the audio signals represents a musical instrument that is played in order to generate a selected one of the audio signals.

8. The system of claim 1, wherein the selected sound effect is selected from the group consisting of:
a) chorus;
b) flange;
c) tremolo;
d) wah; and
e) harmonization.

9. The system of claim 1, further comprising:
a musical instrument operable to generate the audio signal, wherein the musical instrument includes the audio processing module coupled thereto.

10. The system of claim 1, wherein the result is communicated to a selected one of an amplifier and a music sound board.

11. The system of claim 1, further comprising:
a codec operable to facilitate the conversion of the audio signal from an analog format to a digital format such that the selected sound effect may be digitally integrated with the audio signal.

12. A method for processing an audio signal, comprising:
receiving an audio signal;
integrating the audio signal with a selected one of a plurality of sound effects;
generating an output that reflects the integration of the audio signal and the selected sound effect; and
communicating the output to a next destination.

13. The method of claim 12, further comprising:
storing a file associated with the selected sound effect; and
accessing the file associated with the selected sound effect such that the selected sound effect may be integrated with the audio signal.

14. The method of claim 12, further comprising:
tuning the audio signal as the selected sound effect is integrated with the audio signal.

15. The method of claim 12, further comprising:
providing a pathway for downloading one or more files associated with one or more sound effects such that one or more of the sound effects may be integrated with the audio signal.

16. The method of claim 12, wherein the next destination is a selected one of an amplifier and a music sound board.

17. The method of claim 12, further comprising:
integrating the selected sound effect at a specific time interval associated with a channel of the audio signal, wherein the channel represents a musical track generated by an instrument.

18. The method of claim 12, further comprising:
communicating one or more files associated with one or more sound effects to be integrated with the audio signal using a Bluetooth communications protocol.

19. An audio processing module for processing an audio signal, comprising:
a programmable interface operable to receive one or more files associated with one or more sound effects to be integrated with an audio signal received by the audio processing module, wherein the audio processing module is operable to receive the audio signal and to integrate a selected one or more of the sound effects with the audio signal, the audio processing module operable to generate an audio signal output that reflects the integration of the selected sound effect and the audio signal; and
a mechanical interface operable to provide a manual adjustment for tuning the audio signal as it is integrated with the selected sound effect.

20. The audio processing module of claim 19, further comprising:
a wireless device operable to store one or more files associated with one or more sound effects, wherein the wireless device downloads one or more of the files using a Bluetooth communications protocol; and
a plurality of audio signals received by the audio processing module and digitally processed such that one or more of the sound effects are integrated into one or more of the audio signals, wherein each of the audio signals represents a musical instrument that is played in order to generate a selected one of the audio signals.
